(19) United States
(12) Patent Application Publication
(10) Pub. No.: US 2005/0139269 A1
(43) Pub. Date: Jun. 30, 2005

(54) Auto cycled pipeline system

(75) Inventor: Chien-Ching Chen, Hsin-Chu (TW)

Correspondence Address: SQUIRE, SANDERS & DEMPSEY L.L.P, 600 HANSEN WAY, PALO ALTO, CA, 94304-1043, US

(73) Assignee: SiS Microelectronics Corporation, Hsin-Chu (TW)

(21) Appl. No.: 10/748,348

(22) Filed: Dec. 29, 2003

(51) Int. Cl. G05D 7/00

(52) U.S. Cl. 137/565.33

(57) ABSTRACT

An auto cycled pipeline system includes a plurality of main pipes, a plurality of cycle pipes, and a plurality of control values. The plurality of main pipes arranged in parallel and used to pump the fluid, and one side of each main pipe is connected to an inlet pipe, the other side of each main pipe is connected to an exit pipe. Each main pipe has a check value and a cycle pipe. One side of each cycle pipe is attached to a foregoing joint in front of the check value and the other side is attached to a rearward joint behind the check value of each main pipe. And each cycle pipe has a control value. The stagnant fluid in the stopped main pipe can be cycled by the cycle pipe of the pipeline system automatically, to prevent deterioration and to keep the purity of the fluid in the pipeline system.

### BACKGROUND OF THE INVENTION

1. Field of the Invention

The present invention relates to a fluid supply system and more particularly to an auto cycled pipeline system that keeps the fluid clean by preventing stagnant fluid in pipes.

2. Description of the Prior Art

In semiconductor manufacture, a large amount of high-grade gas or pure water is used in various processes such as chemical vapor deposition, dry etching, sputtering and cleaning. When the purity of high-grade gas or pure water become unstable, not only the yield rate of process is reduced but also the machine be damaged. Therefore, how to control the purity of fluid in the supply pipeline system becomes an important issue.

FIG. 1 shows a typical supply pipeline system for ultra pure water supply. Referring to FIG. 1, main pipe A 110, main pipe B 120 and auxiliary main pipe 130 are arranged in parallel between an inlet pipe 100 and an exit pipeline 105. Each main pipe includes an inlet value 141 [symbol] 142 [symbol] 143, a pump 151 [symbol] 152 [symbol] 153, a check value 161 [symbol] 162 [symbol] 163 and an exhaust value 171 [symbol] 172 [symbol] 173. The inlet values 141 [symbol] 142 [symbol] 143 and the exhaust values 171 [symbol] 172 [symbol] 173 are used to open or close the entrance and the exit of each main pipe and control the water flow of each main pipe. The pumps 151 [symbol] 152 [symbol] 153 are used to pump ultra pure water and the check values 161 [symbol] 162 [symbol] 163 are used to prevent reflex. When general operating, only main pipe A 110 and main pipe B 120 are at work of the pipeline system, the auxiliary main pipe 130 will be used only during exigent failure of other main pipe or annual repair of the pipeline system. When pump 151 and pump 152 turn on, ultra pure water will flow into the inlet pipe 100 firstly, then flow through the main pipe A 110 and the main pipe B 120, and flow from the exit pipe 105 finally. Therefore, a stagnant fluid area 180 will be formed in the auxiliary main pipe 130 and the deteriorated ultra pure water forms in the stagnant fluid area 180. If the deteriorated water in the stagnant fluid area 180 is not cleaned out of the auxiliary main pipe 130 before the start of operation, the ultra pure water in the pipeline system will be polluted and yield rate of process reduced.

If an area of stagnant fluid is formed in the auxiliary main pipe, the ultra pure water will be easily polluted and it will be difficult to clean the deteriorated water out. Therefore, the present invention provides an auto cycled pipeline system to keep the fluid in the auxiliary main pipeline in a cycled flow situation.

### SUMMARY OF THE INVENTION

One objective of the present invention is to prevent the stagnant fluid area with deteriorated water from forming in the auxiliary main pipe by the auto cycled pipeline system, to keep high purity of fluid in the supply pipeline system and an excellent yield rate in the process.

The other objective of the present invention is to prevent the area with stagnant fluid and deteriorated water from forming in the auxiliary main pipe, it is not necessary to clean the auxiliary main pipe before working and can be used immediately.

The other objective of the present invention is to keep the fluid in auxiliary main pipe cycling and flowing by the auto cycled pipeline system and without any manpower or energy consumption.

The present invention provides an auto cycled pipeline system including a plurality of main pipes, a plurality of cycle pipes, and a plurality of control values. The plurality of main pipes arranged in parallel and used to pump the fluid, and one side of each main pipe is connected to an inlet pipe, the other side of each main pipe is connected to an exit pipe. Each main pipe has a check value and a cycle pipe. One side of each cycle pipe is attached to a foregoing joint in front of the check value and the other side is attached to a rearward joint behind the check value of each main pipe. And each cycle pipe has a control value. The stagnant fluid in the stopped main pipe can be cycled by the cycle pipe of the pipeline system automatically, to prevent deterioration and to keep the purity of the fluid in the pipeline system.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a traditional ultra pure water supply pipeline system.

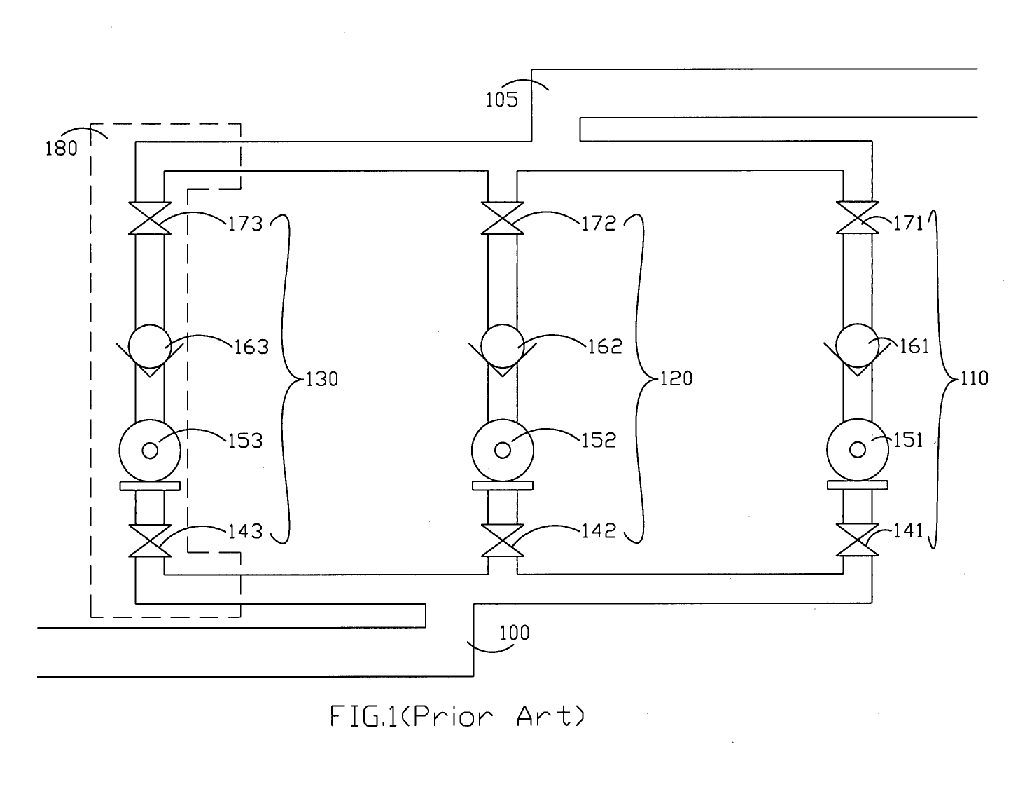

FIG. 2 shows an auto cycled pipeline system of the present invention.

### DESCRIPTION OF THE PREFERRED EMBODIMENT

Some embodiments of the invention will be described exquisitely below. Besides, the invention can also be practiced extensively in other embodiments. That is to say, the scope of the invention should not be restricted by the proposed embodiments. The scope of the invention should be based on the claims proposed later. Then, the components of the supply pipeline system are not shown to scale. Some dimensions are exaggerated to the related components to provide a more clear description and comprehension of the present invention.

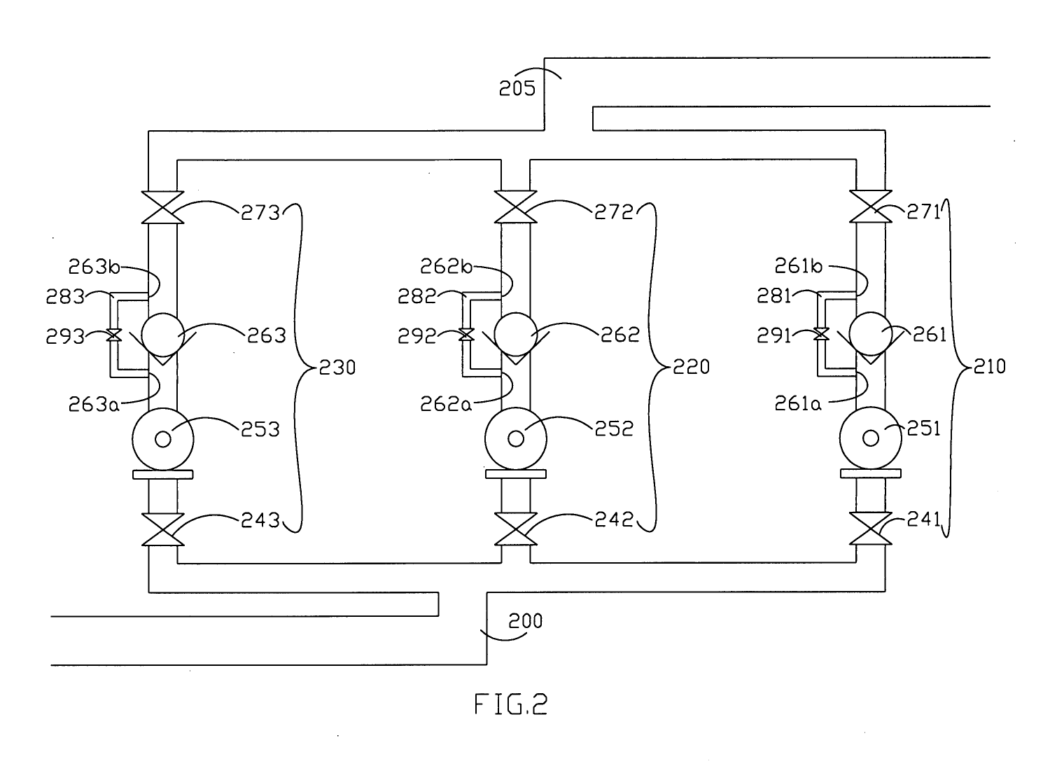

FIG. 2 shows that apply the auto cycled pipeline system to ultra pure water supply pipeline system. Referring to FIG. 2, main pipe A 210, main pipe B 220 and auxiliary main pipe 230 are arranged in parallel, one side of each main pipe connecting to an inlet pipe 200 and the other side of each main pipe connecting to an exit pipe 205. Generally speaking, the farther side of the inlet pipe 200 connecting to an ultra pure water tank or any supply source and the farther side of the exit pipe 205 connecting to the process station directly. It means that the ultra pure water has been defecated before flow into the inlet pipe 200. In this embodiment, the material of main pipe A 210, main pipe B 220, auxiliary main pipe 230 and inlet pipe 200 are stainless steel, and exit pipe 205 is Polyvinylidene Fluoride (PVDF). Each main pipe also has an inlet value 241 [symbol] 242 [symbol] 243, a pump 251 [symbol] 252 [symbol] 253, a check value 261 [symbol] 262 [symbol] 263 and an exhaust value 271 [symbol] 272 [symbol] 273. The inlet values 241 [symbol] 242 [symbol] 243 are used to control the water flow of the entrance of each main pipe and the exhaust values 271 [symbol] 272 [symbol] 273 are used to control the water flow of the exit of each main pipe. The pumps 251 [symbol] 252 [symbol] 253 are used to pump ultra pure water from the tank, and the check values 261 [symbol] 262 [symbol] 263 are used to prevent reflex or short cycle in the auxiliary main pipe.

Next, a cycle pipe 281 is attached on the main pipe A 210, a cycle pipe 282 is attached on the main pipe B 220 and a cycle pipe 283 is attached on the auxiliary main pipe 230. And a control value 291 is attached on the cycle pipe 281, a control value 292 is attached on the cycle pipe 282 and a control value 293 is attached on the cycle pipe 283. One side of each cycle pipe is connected to a foregoing joint 261a-263a in front of the check value and the other side of each cycle pipe is connected to a rearward joint 261b-263b behind the check value of each main pipe. Originally the reflex water flow is intercepted by the check value 261 [symbol] 262 [symbol] 263, the reflex water flow can flow to the direction of the inlet value 241 [symbol] 242 [symbol] 243 by the cycle pipe 281, 282 and 283. The cycle pipes 281, 282 and 283 can be a stainless steel pipe with 0.25-inch caliber. The object for attaching control value 291, 292 and 293 is to open or close the cycle pipe 281, 282 and 283.

Sequentially, referring to FIG. 2, describing how to control the direction of water flow of the pipeline system in the present embodiment mentioned above. If the auxiliary main pipe 230 is not used, it means that the pump 253 is stopped and the control value 293 is open. Ultra pure water flow into the inlet pipe 200 firstly, then into the main pipe A 210 and main pipe B 220 by the function of the pump 251 and pump 252. Because the control value 291 and the control value 292 are now closed, the flow of Ultra pure water is prevented from entering into the cycle pipe 281 and cycle pipe 282, but passes through the exhaust value 271 and exhaust value 272 and flows from the exit pipe 205. On the other hand, because the higher water pressure in the exit pipe 205 compared with the inlet pipe 200, a small amount of the ultra pure water in the exit pipe 205 will reflex to the auxiliary main pipe 230. And because the function of the check value 263, the reflex ultra pure water can only flow into the cycle pipe 283 from the rearward joint 263b to the foregoing joint 263a, then flow to the inlet value 243. Finally, the main pipe A 210 and main pipe B 220 recycles the reflex ultra pure water again.

When it needs to exchange its main pipe of the water supply pipeline system used to pumping ultra pure water, and if the auxiliary main pipe 230 is in motion then the main pipe B 220 is stopped. It needs to turn on the pump 253 and the control value 292 and turn off the pump 252 and the control value 293. Ultra pure water flows into the inlet pipe 200 firstly, and then into the main pipe A 210 and auxiliary main pipe 230 by the function of the pump 251 and pump 253. Because the control value 291 and the control value 293 are closed now, the ultra pure water can not flow into the cycle pipeline 281 and cycle pipeline 283, but must pass through the exhaust value 271 and exhaust value 272 and flow into the exit pipe 205. On the other hand, because the high water pressure of the exit pipe 205, a small amount of the ultra pure water in the exit pipe 205 will reflex to the main pipe B 220. And because the function of the check value 262, the reflex ultra pure water can only pass through the cycle pipeline 282 from the rearward joint 262b to the foregoing joint 262a, then flow to the inlet value 242. Finally, the main pipe A 210 and the auxiliary main pipe 230 recycle the reflex ultra pure water again. In the embodiment mentioned above, the inlet value and exhaust value of each main pipe has to be kept open during normal operation of the water supply system. If the main pipe inlet value or exhaust value is closed, the main pipe will lose its function of pumping.

Besides, because the diameter of the attached cycle pipes 281 [symbol] 282 [symbol] 283 are greatly smaller than the inlet pipe 200 and the exit pipe 205, the additional energy consumption of the reflex water flow is small. On the other hand, besides the check value of each main pipe included between the foregoing joint and the rearward joint, the pump of each main pipe can also be included. It means that the cycled water flow can not be pumped by the other main pipes and then flow through the check value and the pump after flowing into the exhaust value, the cycle pipe and the inlet value. Therefore, the location of the pump of the main pipe will not influence the function of the cycle pipeline, and the location of the check value and the pump can be exchanged. But the inlet value and the exhaust value can not be included in the place between the foregoing joint and the rearward joint. In other embodiments, the inlet value and the exhaust value of each main pipe can be omitted.

Mentioned-above is a preferred embodiment. In factual water supply system, the number of the main pipes and the cycle pipes are not limited, and not all the main pipes have to be attached to a cycle pipe. The number of normally used main pipes and auxiliary main pipes also not limited. In other preferred embodiments, the supply pipeline system can be designed so that only auxiliary main pipes have a cycle pipe.

The present invention provides an auto cycled pipeline system. Even if the pump of any main pipe suddenly stops, the fluid in the main pipe can be cycled by the attached cycle pipe. The auto cycled pipeline system is not only used in ultra pure water supply pipeline system, but also any liquid or gas which needs to maintain high purity.

Although specific embodiments have been illustrated and described, it will be obvious to those skilled in the art that various modifications may be made without departing from what is intended, but not to be limited solely by the appended claims.

1. An auto cycled pipeline system, comprising:
a plurality of main pipes arranged in parallel, one side of said plurality of main pipes connecting to an inlet pipe and the other side connecting to an exit pipe, and each said main pipe has a check value;
a plurality of cycle pipes, one side of each said cycle pipe connecting to a foregoing joint in front of said check value and the other side of each said cycle pipe connecting to a rearward joint behind said check value of each said main pipe; and
a plurality of control values, each said control value attaching on each said cycle pipe.

2. The auto cycled pipeline system according to claim 1, wherein said plurality of cycle pipes are used to cycle a liquid.

3. The auto cycled pipeline system according to claim 1, wherein said plurality of cycle pipes are used to cycle a gas.

4. The auto cycled pipeline system according to claim 1, further comprising to attach a pump on each said main pipe, used to pump said liquid or said gas.

5. The auto cycled pipeline system according to claim 4, further comprising to attach said pump between said foregoing joint and said rearward joint.

6. The auto cycled pipeline system according to claim 1, further comprising when one of said plurality main pipes stop pumping, open said control value.

7. The auto cycled pipeline system according to claim 1, further comprising when one of said plurality main pipes start pumping, close said control value.

8. An auto cycled ultra pure water supply pipeline system, comprising:
a plurality of main pipes arranged in parallel, one side of said plurality of main pipes connecting to an inlet pipe and the other side connecting to an exit pipe, and each said main pipe has an inlet value, a pump, a check value and an exhaust value;
a plurality of cycle pipes, one side of each said cycle pipe connecting to a foregoing joint in front of said check value and the other side of each said cycle pipe connecting to a rearward joint behind said check value of each said main pipe; and
a plurality of control values, each said control value attaching on each said cycle pipe.

9. The auto cycled ultra pure water supply pipeline system according to claim 8, wherein said inlet value attaching on the place near said inlet pipe of each said main pipe.

10. The auto cycled ultra pure water supply pipeline system according to claim 8, wherein said exhaust value attaching on the place near said exit pipe of each said main pipe.

11. The auto cycled ultra pure water supply pipeline system according to claim 8, wherein said pump and said check value are located between said inlet value and said exhaust value of each said main pipe.

12. The auto cycled ultra pure water supply pipeline system according to claim 8, wherein the material of said plurality of cycle pipes is stainless steel.

13. The auto cycled ultra pure water supply pipeline system according to claim 8, wherein the diameter of said plurality of cycle pipes is 1/4 inch.

14. The auto cycled ultra pure water supply pipeline system according to claim 8, further comprising to attach said pump between said foregoing joint and said rearward joint.

15. The auto cycled ultra pure water supply pipeline system according to claim 8, further comprising when one of said plurality main pipes stop pumping, open said control value.

16. The auto cycled ultra pure water supply pipeline system according to claim 8, further comprising when one of said plurality main pipes start pumping, close said control value.

17. The auto cycled ultra pure water supply pipeline system according to claim 8, further comprising to open said inlet value and said exhaust value of each said main pipe, to maintain the function of each said main pipe when normal operating.
